(19) United States
(12) Patent Application Publication
(10) Pub. No.: US 2026/0338365 A1
(43) Pub. Date: Oct. 29, 2026

(54) Flat Panel Display Module With Three Dimensional Sculpture Frame Stand Featuring Animated Movement, Lighting, Sound, and Motion Sensor Functions

(71) Applicant: Michael Kidakarn, Redondo Beach, CA (US)

(72) Inventor: Michael Kidakarn, Redondo Beach, CA (US)

(21) Appl. No.: 19/189,306

(22) Filed: Apr. 25, 2025

(51) Int. Cl. F21V 23/04; F21W 121/00; F21Y 115/10

(52) U.S. Cl. CPC F21V 23/0471; F21W 2121/00; F21W 2121/008; F21Y 2115/10

(57) ABSTRACT

Disclosed herein is a multifunctional flat panel display module is disclosed, integrated with a three-dimensional sculpture frame stand. This invention addresses the instability of traditional thin display modules, which often tip over when force is applied via touch-sensitive screens. The three-dimensional frame stand features a broad, weighted base that provides structural support and stabilizes the display at a 90-degree angle, enhancing both visibility and touch usability. Beyond functional support, the sculpture stand incorporates decorative and interactive elements including motion-activated lighting, animated visual effects, audio playback, and mechanical motion features. These additional utilities transform the display into a dynamic, ambient object that functions as both an electronic display and a decorative element, even when the screen is powered off. Lighting effects such as flickering candlelight, ceiling projections, and color transitions add immersive appeal, while built-in motion sensors activate features only when needed.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention pertains to the field of consumer electronics and decorative electronic accessories. More specifically, it relates to flat panel display modules, such as digital picture or video frames, that incorporate functional and aesthetic structural support. The invention combines practical utility—such as stability during touch interaction—with enhanced user experience features like lighting, motion sensors, sound, and animated movement. The invention addresses issues of display tipping by integrating a sculptural, weighted base while doubling as a decorative art piece or figurine.

### Description of the Related Art

Flat panel display modules, such as digital photo frames, touchscreen kiosks, and smart display units, have become increasingly popular in both consumer and commercial settings. These displays are characterized by their lightweight and slim design, enabling convenient placement in homes, retail stores, offices, and entertainment venues. However, their very design often sacrifices stability, particularly when touch interaction is required. As touchscreen use becomes more prevalent, the need for a stable, interactive, and multifunctional support structure has become critical. The lack of physical foundation in most current models leads to tipping hazards, device damage, and user frustration.

The invention addresses a vital yet overlooked need in the digital display space—providing a stable, multifunctional, and aesthetically appealing display module stand. With the integration of tactile interactivity, lighting, audio, and motion detection, this invention enhances the practical use of flat displays while transforming them into decorative and immersive experiences. This is especially important in environments like children's rooms, entertainment lounges, museum exhibits, and point-of-sale displays, where both stability and engagement are key. The invention not only improves functionality but also aligns with growing consumer expectations for products that merge utility with design and interactivity.

According to industry reports, the global digital signage market is expected to reach $45 billion USD by 2030, growing at a CAGR of over 7%. Meanwhile, smart home devices, which include digital photo frames and interactive displays, are forecasted to exceed $200 billion USD by 2027. A significant percentage of these devices are used in home and public spaces where decor, safety, and functionality converge. Surveys reveal that over 60% of users prefer smart displays that serve multiple purposes—such as entertainment, information, ambiance, and decoration—rather than a single-use device. Furthermore, nearly 40% of touchscreen display returns are linked to accidental drops or instability during use, highlighting a clear design vulnerability.

Various manufacturers have attempted to incorporate functional improvements in digital frames and displays. Some models include basic kickstands or wall mounts, while others offer voice control, limited ambient lighting, or simple sound playback. However, these solutions often lack structural stability, especially for free-standing models, and rarely combine utility with aesthetic appeal. Patents exist for modular display frames and adjustable mounts, but they often address only one aspect of the user need—either functionality or visual design—without unifying both. Moreover, lighting and sound functionalities are seldom integrated into the physical structure of the display, especially not as part of a themed sculptural design.

By looking at prior art, multiple innovations have been seen in prior art. For instance, a US patent 2,011,0116002A1 relates to Flat panel display module. The display module includes a planar display panel being a liquid crystal display panel, a frame disposed under the planar display panel, a lower bezel disposed outside the frame, an upper bezel disposed outside the planar display panel, and a back light module disposed inside the frame. The frame includes at least one side wall. The outer surface of the side wall includes a plurality of tenons and a fixing plate is coupled to the side wall. The fixing plate is contacted with a side of the planar display panel. The side wall of the lower bezel includes a first hole corresponding to a first tenon so that the first tenon can be engaged with the first hole. The side wall of the upper bezel includes at least one second hole corresponding to a second tenon so that the second tenon can be engaged with the second hole.

A U.S. Pat. No. 9,265,182B2Fl relates to flat panel display. The flat panel display (FPD) including a display panel for displaying an image; a film substrate electrically connected to the display panel, the film substrate including driving circuits; a printed circuit board (PCB) electrically connected to the film substrate, the printed circuit board providing a signal for displaying the image; and a heat radiating unit attached to one surface of the film substrate, the heat radiating unit contacting at least one of the display panel and the PCB.

A US patent 2,004,0004761A1 relates to flat-panel display. The flat-panel display comprises a projector (21-23) illuminated by a collimate light source such as an infra-red laser, a waveguide (1) which ejects rays at a distance along the axis of propagation related to their angle of injection into the edge of the waveguide, an input slab (3) for magnifying the projected image in the width dimension in the plane of the panel perpendicular to the axis of propagation, and a phosphor output screen which converts the infra-red light to the visible. The use of monochromatic light within the waveguide reduces dispersion problems, and the use of a triad of projectors, each injecting at a different angle, makes registration relatively simple.

The U.S. Pat. No. 6,975,308 B 1 relates to digital picture display frame. The present invention provides a picture frame for displaying digital images taken by a digital camera. The invention may be a wall mounted frame or a desk top frame. The invention includes a display, such as an active matrix display for rendering images for viewing. The invention includes an interface for manipulating images by using a graphical user interface in conjunction with an operating system. The present invention may be employed for displaying overhead projection slides for conferences, lectures and meetings. The invention includes sensors for monitoring conditions in areas around the frame. The frame includes floppy disk and CD/DVD drives for transferring data to a memory of the frame. The memory of the frame is used to store images and may select images according to a program or list.

The US patent 2,018,0278899A1 relates to Interactive display. The imaging device for an interactive display includes at least one image projector to project an image onto a display area. The imaging device further includes a number of image capture devices to capture at least one image of the display area, and a number of sensors to detect the presence of an object within the field of view of the image capture devices.

The US patent 2,014,0210799A1 relates to Interactive Display System and Method. The present disclosure describes an interactive display system, method and computer readable medium. In one embodiment, an interactive display surface having one or more computer generated patterns printed thereon may be utilized in conjunction with an electronic pen in order to identify the absolute position of the pen relative to the interactive display surface. In one embodiment, the absolute position of the electronic pen may be transmitted to a computer system and utilized to control one or more programs running on the computer system. In one embodiment, the visual output of the computer system may be superimposed upon the interactive display surface using one or more projectors. The computer generated patterns may have a predefined association with a control operation of the computer system such that placing the electronic pen in proximity to the associated generated pattern causes the computer system to execute the associated control operation.

Despite advancements, users still struggle with several key issues when using flat panel displays: lack of stability during touch interaction, limited interactivity, absence of aesthetic integration into living or themed environments, and the inconvenience of accessing controls. Additionally, many standalone digital frames appear bland or technical, clashing with home decor. Devices with motion sensors or lighting are typically expensive, complex, or not child-friendly. There is a significant lack of options that seamlessly combine artistic design, structural utility, and immersive features in one plug-and-play solution.

To address these long-standing issues, the present invention introduces a Flat Panel Display Module with a Three-Dimensional Sculpture Frame Stand. This invention transforms a basic digital frame into an immersive, interactive, and decorative centerpiece. It supports the screen at a stable and optimal viewing angle, integrates motion-activated lighting (with animated effects), sound, and even ceiling projections to create an engaging and multi-sensory user experience. The sculpture is not just decorative—it is engineered to provide real physical stability and aesthetic satisfaction. Each element of the frame, from translucent lenses to strategically placed motion sensors and speakers, is carefully designed to enhance both function and form.

This invention brings together a multitude of user-focused features in a single cohesive unit. It provides a heavy, wide-based stand that ensures the digital screen remains upright even under physical interaction. The 3D sculptural frame not only supports the display structurally but serves as an artistic piece, suitable for home décor or thematic settings. Integrated LED lighting, motion detection, ambient sound playback, and projection capabilities enrich the interactive experience while maintaining a user-friendly interface via discreet control buttons. It is also modular in its theme-based sculptural design, allowing for customization and thematic targeting.

This invention also fills a significant gap in the market by merging technology, interactivity, and artistic expression into a single product. No existing display module offers this level of structural integrity while simultaneously providing lighting, sound, and decorative value. For consumers looking for more than just a gadget—for example, parents seeking engaging nightlights for children, retailers creating themed ambiance, or homeowners wanting functional decor—this invention provides a practical yet enchanting solution. The modular nature also allows manufacturers to develop themed collections (e.g., fantasy, wildlife, sci-fi), enhancing marketability across diverse audiences. It satisfies the growing demand for integrated smart decor and makes a compelling case for the evolution of display technology beyond the screen itself.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide an enhanced design flat panel display module with a multi-dimensional sculpture frame stand featuring animated movement, lighting, sound, and motion sensor features.

It is also the objective of the invention to provide a flat panel display module with enhanced structural stability through a sculptural base that prevents tipping when force is applied to a touch-sensitive screen.

A further objective of the present invention is to integrate a decorative and functional three-dimensional sculpture stand that allows the display to remain upright at a 90-degree angle for optimal user interaction and reduced screen glare.

It is also an object of the invention to incorporate motion-activated LED lighting with dynamic effects such as candle flicker and color transitions, enhancing both visibility and aesthetic appeal.

It is further the objective of the invention to provide ambient lighting functions that double as nightlights, useful in low-light environments like bedrooms or themed display areas.

It is also the objective of the invention to include strategically placed motion sensors that automatically activate lighting, sound, and projection features in response to user presence, enhancing interactivity.

The objective of the invention is to integrate a built-in speaker system within the sculpture frame to deliver synchronized sound effects, music, or ambient audio that enhances the multimedia experience.

It is also the objective of the invention to provide an animated ceiling projection system that displays moving star patterns or themed visuals, adding a dynamic layer to room decor and entertainment.

It is further the objective of the invention to offer intuitive function control through buttons integrated seamlessly into the base design, allowing easy user access without disrupting the artistic aesthetic.

The invention aims to serve as a multifunctional device that combines digital display utility with decorative value, making it visually appealing even when the display is turned off.

It is the objective of the invention to support modular customization, allowing users to select from various sculpture themes (e.g., castles, characters, nature) tailored to personal tastes or commercial environments.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the perspective view of the flat panel display module housed within the three-dimensional sculpture frame stand as per preferred embodiments of the invention.

FIG. 2 illustrates the front and back view of the flat panel display module as per preferred embodiments of the invention.

FIG. 3 illustrates the rear and angled side views of the Flat Panel Display Module with its integrated three-dimensional sculpture frame stand as per preferred embodiments of the invention.

FIG. 4 illustrates the front and back view of the flat panel display module as per preferred embodiments of the invention.

FIG. 5 illustrates the front and back view of the flat panel display module as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates generally to the field of flat panel display technologies and more particularly to a flat panel display module with a three-dimensional sculpture frame stand that integrates multiple interactive functions including stability support, motion-activated lighting, audio playback, and animated projection features. This invention resolves the issue of structural instability in conventional digital frames and enhances user experience through an engaging multimedia decorative design.

As per its preferred embodiments, the flat panel display module is encased within a sculpturally themed frame stand that provides a decorative and functional structure. The stand is constructed with a substantial base composed of high-mass material to prevent tipping during interactive touch input. This base may be formed of molded polymer, resin, or other structural materials and styled as a visual element such as a stone base or natural terrain, contributing both to utility and ornamental value.

As per its further embodiments, the vertical sides of the sculpture frame support the digital display at an optimal 90-degree angle, ensuring maximum visibility, reducing light glare, and allowing for ergonomic user interaction. This upright configuration is structurally reinforced by the depth and width of the side panels which act as architectural columns styled with sculptural figures such as knights, serpents, or castle-like motifs. The structure is both thematic and practical, ensuring the digital panel remains in a fixed orientation.

As per its further embodiments, integrated within the sculpture frame are multiple translucent lenses behind which motion-activated LED lighting components are embedded. These lights simulate effects such as candle flicker or magical glowing through programmable LED arrays. The lighting is both ambient and directional, aimed at enhancing the visual appeal of the sculpture and providing gentle room illumination, especially in low-light environments.

As per its further embodiments, the system further includes motion sensors strategically embedded into the upper regions of the sculpture frame. These sensors detect presence or proximity of a user and automatically trigger associated responses such as light activation, sound effects, or projection animations. Sensor sensitivity may be tuned for different operational ranges to suit various environments such as children's rooms, themed spaces, or retail displays.

As per its further embodiments, an audio speaker system is embedded within sculptural cavities near the top of the frame. Speaker holes are acoustically tuned and externally invisible or stylistically integrated into the sculpture's design. The speakers may output ambient soundtracks, sound effects synchronized with lighting, or user-defined audio playback. Audio content is user-controllable through integrated buttons or remote control features.

As per its further embodiments, the ceiling projection light mechanism is optionally mounted at the top of the frame and projects animated light patterns, such as stars or thematic imagery, onto the ceiling. This projection feature adds a new dimension to the interaction experience, especially suitable for nighttime use or immersive environments. The animation sequences can be user-configurable or pre-programmed to synchronize with sensor input or audio cues.

As per its further embodiments, the function control buttons are integrated into the base of the sculpture and provide tactile feedback for the user to toggle or adjust the different functionalities of the frame. These include lighting effects, sound playback, projection animation modes, and sensor activation. The buttons are hidden within the base's design and follow the ornamental aesthetic of the sculpture.

As per its further embodiments, the sculpture frame may incorporate animated mechanical elements, such as a moving arm or rotating feature, triggered by user presence or synchronized with sound and light effects. These mechanical components are designed to enhance the interactive quality of the display stand while remaining durable and silent during operation.

As per its further embodiments, the digital display is powered off, the sculpture frame serves as an artistic and ornamental piece. Each design is crafted to function as an aesthetically pleasing structure, independent of its electronic features. The design may take on various themes such as fantasy castles, mythological characters, sports athletes, enchanted forests, or whimsical cartoon animals, each with its own embedded technology tailored to complement the visual theme.

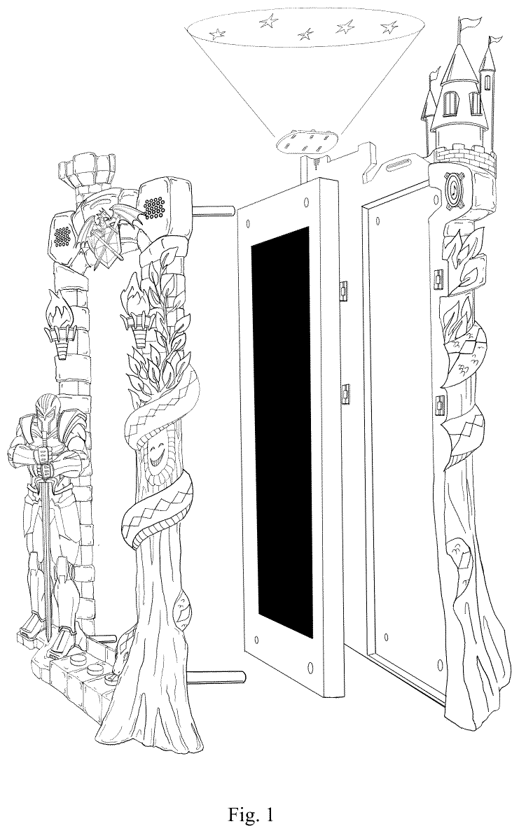

The invention can be further understood by the provided figures. FIG. 1 illustrates a perspective view of the flat panel display module housed within the three-dimensional sculpture frame stand. The left and right columns of the sculpture feature various thematic designs such as a medieval knight, tree-like carvings, snakes, and a castle turret. These sculptural features encase and support the flat display module positioned centrally.

The left vertical sculpture includes multiple translucent lenses behind which LED lights are positioned to simulate torchlight or magical glow. A knight figure, depicted gripping a sword, is carved into the structure, offering a visually commanding presence. Speaker holes are placed in the upper crown of the arch where audio playback is emitted, and a motion sensor hole is located above the display to trigger lighting and sound responses.

The right sculpture includes castle towers and dragon-scale textures, with integrated LED lights labeled as having candle flicker animation and motion sensor-aware animation. The side of the sculpture also houses a speaker and a motion sensor, while function control buttons are integrated discreetly into the base. The ceiling projection unit emits animated star patterns, enhancing the ambient experience and providing an immersive audiovisual environment when the device is active.

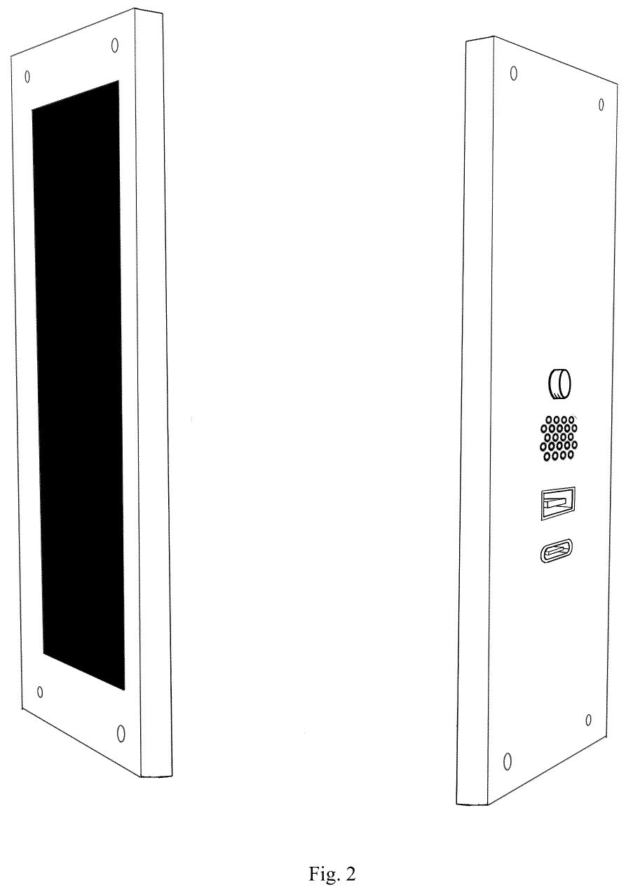

FIG. 2 shows the complete assembly front and back display. This image illustrates the core Flat Panel Display Module without the sculpture frame. It is a vertically oriented rectangular screen, thin in profile, with front and back views. The front is dominated by the black display area, while the back includes ports (like USB and HDMI), ventilation holes, and possibly buttons or sensors.

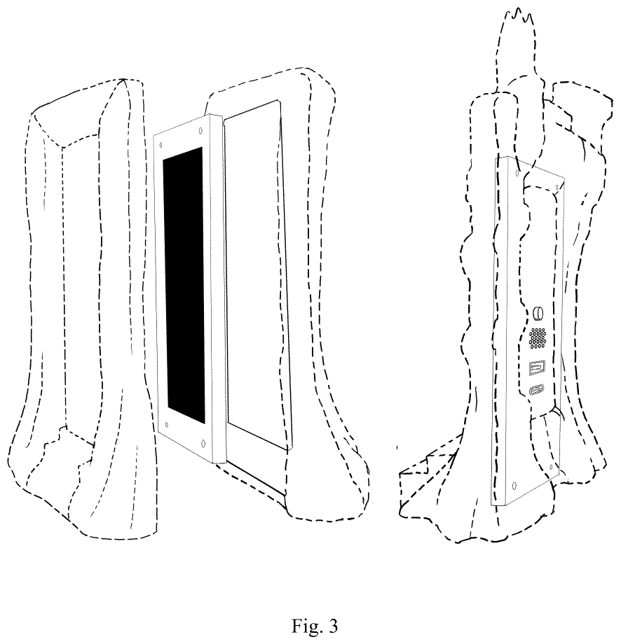

FIG. 3 shows the rear and angled side views of the Flat Panel Display Module with its integrated Three-Dimensional Sculpture Frame Stand. These views provide valuable insight into the structural form, hidden electronic features, and the substantial support mechanism that ensures stability and functionality of the invention. The flat panel display securely embedded between two substantial sculptural elements. These elements are shown in dotted lines to emphasize their decorative and variable nature, while the core flat panel remains consistent in design. The sculptural contours suggest tree trunk or naturalistic themes, demonstrating that the 3D frame stand can adopt aesthetic forms while providing a stable, weight-bearing base. This stability is critical for supporting touch interactions on the display without tipping.

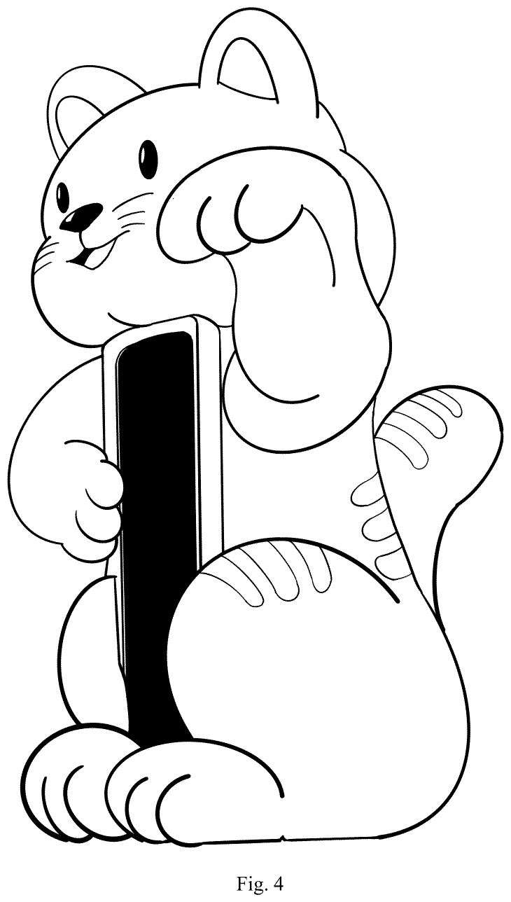

FIG. 4 depicts the display module integrated into a three-dimensional sculpture of a waving cat. The cat holds the display vertically, acting as a supportive stand. The wide base (formed by the cat's body and feet) provides stability, counteracting the tipping problem described in the product overview. This sculpture not only serves as a decorative element but also improves functionality.

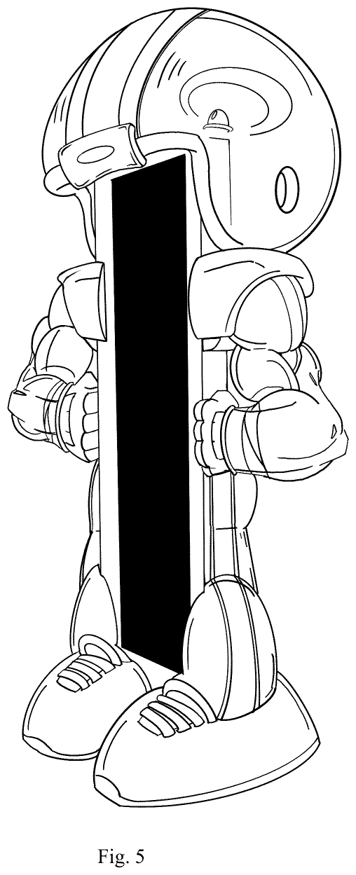

FIG. 5 shows a robot-themed three-dimensional sculpture holding the display panel in front of its torso. Like the cat sculpture, the robot has a large base and arms grasping the screen, stabilizing the thin display for upright use. The robot's design allows for strategic placement of lights—such as in the eyes, helmet, or base—to enhance its futuristic appearance. The robust build of the robot also allows for motion components, like head or arm movement, and integrated speakers for sound effects.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A flat panel display module comprising:
a three-dimensional sculpture frame stand configured to stably support the display at approximately a 90-degree vertical viewing angle, wherein the frame includes:
a sculptural base with sufficient weight; and,
surface area to resist tipping due to user interaction with a touch-sensitive screen.

2. The invention of claim 1, wherein the sculptural base includes a fantasy or character-themed structure forming a visually decorative environment.

3. The flat panel display module of claim 1, further comprising motion-activated lighting features integrated within the sculpture frame, said lighting elements being operable to simulate effects such as candle flicker and dynamic color transitions.

4. The invention of claim 1, wherein said lighting is activated by motion sensors and selectively illuminates translucent lenses embedded in the sculpture.

5. The invention of claim 1, wherein the lighting includes an LED configuration designed for ambient or decorative purposes.

6. The flat panel display module of claim 1, wherein the sculpture frame includes interactive elements comprising:
a. speaker components for sound playback,
b. motion sensors for activating lights or animations, and
c. animated lighting projection features for ceiling display.

7. The invention of claim 1, wherein motion sensors are calibrated to detect proximity and trigger specific light or sound responses.

8. The invention of claim 1, wherein speaker holes are acoustically positioned within the upper sculpture to direct sound toward the user.

9. The invention of claim 1, wherein ceiling projection lights display animated stars and other patterns.

10. The invention of claim 1, wherein function control buttons at the sculpture base enable user selection of light, sound, and motion features independently.
